(19) United States
(12) Patent Application Publication
(10) Pub. No.: US 2022/0165182 A1
(43) Pub. Date: May 26, 2022

(54) SURGICAL OPERATION TRAINING SIMULATOR

(71) Applicant: BONE 3D, Paris (FR)

(72) Inventors: Juliette PREBOT, Paris (FR); Stéphane GAILLARD, Rueil-Malmaison (FR); Jérémy ADAM, Paris (FR)

(21) Appl. No.: 17/608,330

(22) PCT Filed: Apr. 30, 2020
(86) PCT No.: PCT/EP2020/062168

§ 371 Date: Nov. 2, 2021

(30) Foreign Application Priority Data
May 3, 2019 (FR) FR1904693

(51) Int. Cl. G09B 23/30

(52) U.S. Cl. CPC G09B 23/30

(57) ABSTRACT

A surgical operation training simulator having an assembly which anatomically reproduces at least one portion of a human or animal body, wherein the assembly is in one piece and includes at least: a first hard anatomical component made of a first polymeric compound having a first hardness, a second soft anatomical component made of a second polymeric compound, the second polymeric compound having a lower hardness than that of the first polymeric compound, the first hard anatomical component and the second soft anatomical component being rigidly connected to each other. The invention also relates to a method for manufacturing the aforementioned simulator.

### FIELD OF THE INVENTION

The invention relates to the technical field of surgical operation training simulators.

### BACKGROUND OF THE INVENTION

Virtual surgical operation training simulators are already known in the prior art. They reproduce the elements and conditions of a surgical operation on screen, the latter being combined with a training interface.

However, the cost of these simulators is high, they are not easy to move, and, since they take up considerable space, they are unsuitable for use by a large number of simultaneous users. Moreover, such simulators although equipped with haptic feedback do not correctly reproduce the sensations experienced during a surgical operation, for example during contact, scraping or perforation of a soft, hard or even brittle anatomical component. In addition, these simulators do not reproduce the constraints related to a surgical operation, since they do not imitate the constraints related to the materials, the connections between anatomical components and the anatomical spatial constraints of such a surgical operation.

There is therefore a need, in a surgical operation training simulator, to realistically reproduce the sensations experienced by a practitioner during a surgical operation.

Silicone-based surgical operation training simulators are also known, which reproduce the sensations experienced during a surgical operation more faithfully. These simulators may comprise several anatomical components of different hardnesses, for example tissues and bone elements, to reproduce the sensations experienced by a practitioner during the surgical operation performed for the purposes of the training. In these simulators, each component is manufactured individually, then positioned or assembled with the other elements to form the simulator. The user of the simulator then performs a training surgical operation on the simulator.

However, these simulators are complex to assemble, since assembly is often carried out by hand, and are therefore expensive. In addition, these simulators do not realistically simulate at least some anatomical conditions, or anatomical cases, required for the surgical operation training, such as for example the presence of a tumour fully contained inside an organ.

### SUMMARY OF THE INVENTION

The invention aims in particular to provide a surgical operation training simulator to realistically reproduce the anatomical conditions of a surgical operation and the sensations experienced during this operation, and which in addition is easy and inexpensive to manufacture.

The invention therefore relates to a surgical operation training simulator having an assembly which anatomically reproduces at least one portion of a human or animal body, the simulator being characterised in that the assembly is in one piece and comprises at least:
a first hard anatomical component consisting of a first polymeric compound having a first hardness,
a second soft anatomical component consisting of a second polymeric compound, the second polymeric compound having a lower hardness than that of the first polymeric compound, the first hard anatomical component and the second soft anatomical component being rigidly connected to each other.

Thus, in particular since the assembly is in one piece, the manufacture of such a simulator is particularly easy and inexpensive, and the anatomical conditions of a surgical operation, even unique, can be reproduced more faithfully. There is in fact no need to perform steps of assembling the anatomical components, such that, for example, the anatomical conditions of a surgical operation concerning a specific case can be reproduced simply and rapidly. In addition, the presence of a hard anatomical component and of a soft anatomical component having a lower hardness than that of the hard anatomical component improves the reproduction of the sensations experienced by a user of the simulator, which are therefore similar to the sensations experienced by a practitioner during a surgical operation when soft and hard organs are nested in each other.

In this description, “one-piece” preferably means that an element is manufactured in a single piece, preferably using a single manufacturing technique. Thus, advantageously, in a one-piece assembly, the various elements forming the assembly do not have to be assembled together.

In this description, “rigidly connected” preferably means that one element is connected to another element, either by contact or via an intermediate element. One element can be rigidly connected to another element by shape and/or material complementarity.

According to other optional characteristics of the surgical operation training simulator object of this invention, taken alone or in combination:
the assembly comprises at least a third anatomical component consisting of a third polymeric compound different from the first polymeric compound and from the second polymeric compound, the third, preferably brittle, component reproducing a physical sign representative of a pathology, preferably a tumour. Thus, the sensations experienced by a user of the simulator are made even more realistic. In addition, and particularly advantageously, the material forming the third polymeric compound can be the same as a support material used during the manufacture of the simulator, which is then for example removed under the action of a water jet or other mechanical or manual action, since the material is brittle.
the third polymeric compound is at least partially water-soluble. Thus, for example, the material forming the third polymeric compound can be the same as a support material used during the manufacture of the simulator, which is then for example removed under the action of a water jet.
the assembly comprises a plurality of second soft anatomical components, each second soft anatomical component respectively consisting of a second polymeric compound, each second polymeric compound having a lower hardness than that of the or of each first polymeric compound.
the assembly comprises a plurality of first hard anatomical components, each first hard anatomical component consisting respectively of a first polymeric compound having a first hardness. Thus, the or each second polymeric compound has a lower hardness than that of the or of each first polymeric compound.
at least a first polymeric compound—preferably between 1 and 15, more preferably between 1 and 5, even more preferably 2—has a first hardness different from those of the other first polymeric compounds. The simulator is thus more realistic.
at least a second polymeric compound—preferably between 1 and 15, more preferably between 1 and 6—has a second hardness different from those of the other second polymeric compounds. The simulator is thus more realistic.
the assembly comprises between 1 and 50, preferably between 1 and 15 first hard anatomical components. The simulator is thus more realistic.
the assembly comprises between 1 and 50, preferably between 1 and 15 soft anatomical components. The simulator is thus more realistic.
all the elements forming the assembly are configured to be obtained during a single step of additive synthesis. Thus, since all the elements forming the assembly are manufactured simultaneously, manufacture is simplified and there is no need to assemble these elements together. This avoids a step of assembling the various elements forming the assembly.
the first polymeric compound is a photopolymeric compound. Thus, manufacture is easier, especially using an additive synthesis method.
the second polymeric compound is a photopolymeric compound. Thus, manufacture is easier, especially using an additive synthesis method.
the third polymeric compound is a photopolymeric compound. Thus, manufacture is easier, especially using an additive synthesis method.
the polymeric compounds are photopolymeric compounds. Thus, manufacture is easier, especially using an additive synthesis method.
the second photopolymeric compound comprises at least one elastomer material. Thus, the second soft anatomical component can deform elastically and reversibly, making the sensations experienced by a user of the simulator more realistic.
the first polymeric compound has a Shore D hardness of between 70 and 95, preferably between 83 and 86. A hard anatomical component of hardness similar to the anatomical element that it reproduces can therefore be obtained.
the second polymeric compound has a Shore A hardness of between 20 and 95, preferably between 27 and 60, more preferably between 30 and 35. A soft anatomical component of hardness similar to the anatomical element that it reproduces can therefore be obtained.
the first hard anatomical component reproduces at least partially at least one element selected from the group composed of: a bone element, a cartilaginous element, a keratinous element, a calcic element, an ungular element, a tooth, a carapace, a corn, a cyst, a physical sign representative of a pathology such as a tumour. Thus, by selecting such a first hard anatomical component, the simulator can be applied to a large number of different surgical operations.
the second soft anatomical component reproduces at least partially at least one element selected from the group composed of: a soft tissue, an adipose tissue, a vein, an artery, a nerve, skin, a muscle, a mucous membrane, a ligament, a tendon, a membrane, an organ, a physical sign representative of a pathology such as a tumour. Thus, by selecting such a second soft anatomical component, the simulator can be applied to a large number of different surgical operations.
at least one of the anatomical components contains a liquid reproducing a biological liquid. Thus, the anatomical conditions of a surgical operation and the sensations experienced during this operation are reproduced in a particularly realistic manner. For example, a second soft anatomical component is a vein or an artery, and contains a liquid reproducing the blood, for example a red liquid.
the simulator comprises a support to which the assembly is attached, preferably removably. Thus, the forces applied to the assembly can be transmitted to the support. Furthermore, manufacture is less expensive, since the support only has to be manufactured once, the assembly being interchangeable with the possibility of being changed once the training surgical operation has been completed.
all the elements forming the support are configured to be obtained during a single step of additive synthesis. Thus, since all the elements forming the support are manufactured simultaneously, manufacture is simplified and there is no need to assemble these elements together. This avoids a step of assembling the various elements forming the support.
the simulator comprises a base, the base and the support forming a ball connection between them. Thus, the support can be oriented in all directions using the ball connection, for example by a ball system comprising a ball carried by the support and a ball housing carried by the base. Thus, the user can be trained in various positions of the support, and consequently of the assembly. The user can also choose the position in which he performs the surgical operation training, thus making the training more realistic.
the support anatomically reproduces at least one portion of a human or animal body, the support comprising a shape complementary to the assembly, the assembly preferably reproducing a finger end comprising a nail and the support reproducing a portion complementary to said finger. Thus, the simulator is more realistic, for example as regards the handling of the simulator by a user. For example, the user can thus hold the support, to perform a training surgical operation on the assembly.

In this description, “finger” preferably means a finger or toe, such as for example a big toe.
the assembly and the support form a complete connection together, the complete connection preferably being reversible or frangible without damaging the support.
the assembly and the support form a sliding connection together, whose sliding degree of freedom is blocked by blocking means. Thus, it is particularly easy to position the assembly on the support.
the assembly comprises a groove and the support comprises a tenon, the tenon and the groove forming together a dovetail sliding connection. Thus, the sliding connection is produced in a particularly simple and robust manner.
the blocking means located on the assembly can be destroyed at least partially so that, in the destroyed state, the assembly and the support can be separated. Thus, the assembly cannot be reused.
the blocking means comprise clipping means. Thus, the blocking means are easy to produce.
the blocking means comprise at least one lug carried by the support and at least one housing, carried by the assembly, for receiving the lug. Thus, the blocking means are extremely easy to produce.
the assembly further comprises a unit for maintaining in suspension the second soft anatomical component, the unit consisting of a polymeric, preferably photopolymeric, compound, the first hard anatomical component and the second soft anatomical component being rigidly connected together via the unit. Thus, it is for example possible to anatomically reproduce complex portions separated from each other but necessary for the anatomical reproduction to make the training surgical operation more realistic. It is also possible to anatomically reproduce only portions of interest, the manufacture of the simulator thus requiring less material and thus being less expensive.
the unit comprises at least one peripheral wall to which the second soft anatomical component is connected, the second soft anatomical component being arranged at least partially in the internal space delimited by the unit. Thus, the second soft anatomical component can be suspended in the internal space delimited by the unit, and positioned spatially and precisely using the unit, thereby making the simulator more realistic.
the unit consists of the first polymeric compound. Thus, the simulator is particularly easy to manufacture.
the unit is substantially of polyhedral shape, preferably substantially cubic.
the unit is substantially of polyhedral shape—preferably substantially cubic—open on one side, at least one other side of the unit adjacent to the open side comprising at least one orifice. Thus, the simulator is less expensive, and possibly faster, to manufacture. For example, manufacture of the simulator may require a brittle and/or at least partially water-soluble support material, which can for example be removed under the action of at least a water jet, directed towards said at least one orifice, to obtain a simulator in the finished state.
the unit comprises stiffening means, for example at least one rib and/or at least one fold and/or at least one fillet, preferably a peripheral fold. Thus, this prevents deformation of the unit, in particular during the training surgical operation or the manufacture, which improves the positioning of the second soft anatomical component.

The invention also relates to a method for manufacturing a simulator of the aforementioned type, during which all the elements forming the assembly, respectively the support where applicable, are manufactured simultaneously during a step of additive synthesis, preferably by three-dimensional printing or 3D-printing, more preferably of the material jetting type, such as Polyjet or Multijet. Thus, the simulator is particularly easy and inexpensive to manufacture.

According to other optional characteristics of the method for manufacturing the surgical operation training simulator object of this invention, taken alone or in combination:
the manufacturing method comprises:
   a) a step of displaying a three-dimensional image of a portion of a human or animal body to be modified, the three-dimensional image being called the initial model,
   b) a step of modifying this three-dimensional image to define a first digital model of a first sub-portion of a human or animal body comprising a first modified sub-portion, called the assembly model, the assembly model comprising at least one first sub-model of a first hard anatomical component and at least one second sub-model of a second soft anatomical component,
   c) a step of additive synthesis of the assembly, performed using the assembly model. Thus, the simulator is particularly easy and inexpensive to produce. In addition, the simulator is very easy to change or customise, by simply modifying the three-dimensional image used.
the manufacturing method comprises the following steps:
   a) a step of displaying a three-dimensional image of a portion of a human or animal body to be modified, the three-dimensional image being called the initial model;
   b) a step of modifying this three-dimensional image to define:
a first digital model of a first sub-portion of a human or animal body comprising a first modified sub-portion, called the assembly model, the assembly model comprising at least one first sub-model of a first hard anatomical component and at least one second sub-model of a second soft anatomical component, and
a second digital model of a second sub-portion of a human or animal body complementary to the first sub-portion of a human or animal body, comprising a second modified sub-portion, called the support model;
   c) a preferably unique step of additive synthesis of the assembly, performed using the assembly model;
   d) a preferably unique step of additive synthesis of the support, performed using the support model.

Steps c) and d) can be performed simultaneously or successively, it being possible to perform step c) before step d) and vice versa.

The simulator is thus more realistic. Using a unique step of additive synthesis of the assembly, respectively of the support, manufacture is simplified and there is no need for a step of assembling the various elements forming the assembly, respectively the support.
the manufacturing method comprises, before step a), a step of processing a three-dimensional image of a portion of a human or animal body by segmenting the three-dimensional image into a plurality of three-dimensional elements, amongst which at least two three-dimensional elements each form a digital sub-model representing at least one anatomical component.
the manufacturing method comprises, during step b), modifying the assembly model to integrate therein and/or modify at least one sub-model of physical sign representative of a pathology, preferably a tumour or a malformation.

Thus, a predefined assembly model can be obtained, which is modified according to the surgical operation training needs, by integrating and/or modifying only the sub-model of physical sign representative of a pathology. For example, this sub-model can reproduce a tumour, whose size and position can be modified during this step. Thus, it takes less time to design the assembly model. Furthermore, the assembly model can be adapted to a specific surgical operation training case. Thus, the assembly model can for example reproduce a special case of physical sign occurring only very rarely, for example which does not appear on any of the three-dimensional images available. There is no need for a particular three-dimensional image of a portion of a human or animal body comprising the physical sign representative of a pathology.
the manufacturing method comprises, during step b), modifying the assembly model to integrate therein at least one sub-model of physical sign representative of a pathology, the sub-model forming a third sub-model of a third anatomical component.

This makes the simulator more realistic.
the method comprises, during step b), modifying the assembly model to integrate therein a sub-model of a unit for maintaining in suspension the second soft anatomical component.

Thus, the simulator is easier to manufacture.

### BRIEF DESCRIPTION OF THE FIGURES

The invention will be better understood on reading the following description, given solely by way of example and with reference to the accompanying drawings in which:

FIG. 1 is a perspective view of a simulator according to a first embodiment of the invention, the simulator being a simulator for training on an endoscopic endonasal surgical operation of a pituitary adenoma or of a craniopharyngioma.

FIG. 2 is a front view of the simulator shown on FIG. 1.

FIG. 3 is a top view of the simulator shown on FIG. 1.

FIG. 4 is a cross-sectional view of a simulator according to a first particular example of the first embodiment, the simulator being a simulator for training on an endoscopic endonasal surgical operation of a pituitary microadenoma.

FIG. 5 is a cross-sectional view of a simulator according to a second particular example of the first embodiment, the simulator being a simulator for training on an endoscopic endonasal surgical operation of a pituitary macroadenoma.

FIG. 6 is a cross-sectional view of a simulator according to a third particular example of the first embodiment, the simulator being a simulator for training on an endoscopic endonasal surgical operation of a craniopharyngioma.

FIG. 7 is a perspective view of a simulator according to a second embodiment of the invention, before assembling an assembly forming part of the simulator on a support forming part of the simulator, the simulator being a simulator for training on a surgical operation on an ingrown nail of a toe, in this case a big toe.

FIG. 8 is a rear view of an assembly forming part of the simulator shown on FIG. 7.

FIG. 9 is a front view of the simulator shown on FIG. 7, in the assembled state.

### DETAILED DESCRIPTION

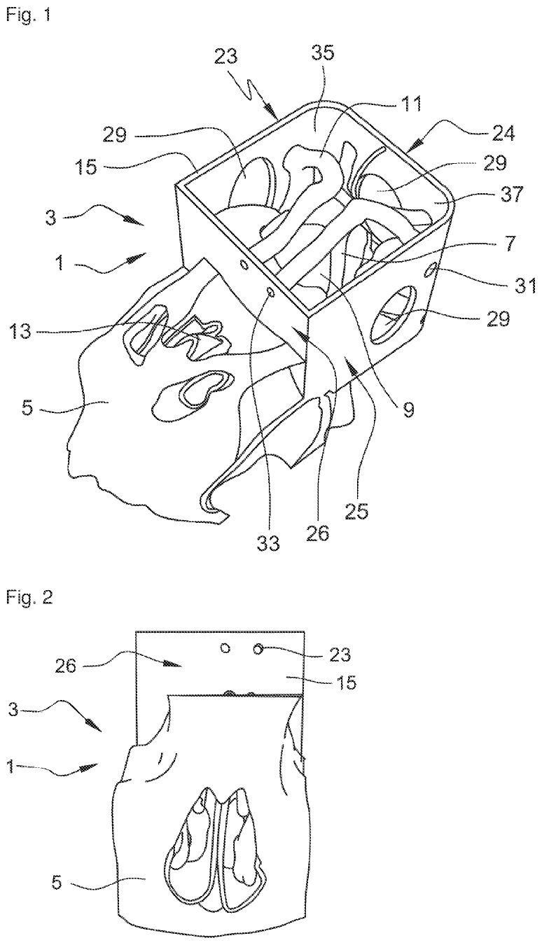

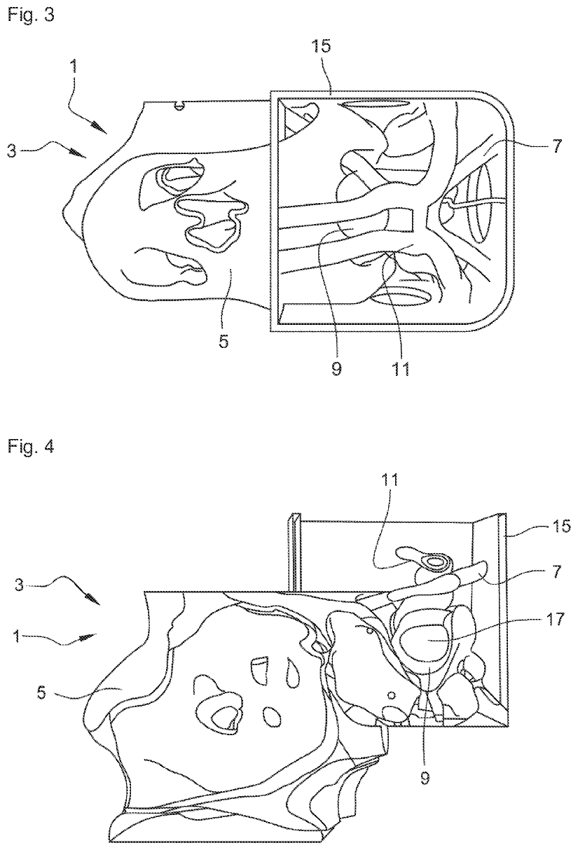

FIGS. 1 to 6 show a surgical operation training simulator according to a first embodiment of the invention, designated by the general reference 1.

In this example, the simulator 1 comprises an assembly 3 anatomically reproducing a portion of a human body, more precisely a portion of a head.

As shown on FIGS. 1 to 6, the assembly 3 is in one piece and comprises a first hard anatomical component 5, the component anatomically reproducing in this example a bone portion, in this case a portion of a skull. The assembly 3 also comprises at least a second soft anatomical component 7, 9, 11, 13. The assembly 3 further comprises a unit 15 for maintaining in suspension the second soft anatomical component 7, 11. Lastly, in the examples shown on FIGS. 4 to 6, the assembly 3 comprises a third anatomical component 17, 19, 21.

In this example, the first hard anatomical component 5 anatomically reproduces a bone portion—in this case a portion of a skull—and a cartilaginous portion of a human head. The first hard anatomical component 5 consists of a first polymeric compound having a first hardness. In this example, the first polymeric compound is a photopolymeric compound.

The following table shows an example of physical characteristics of a first polymeric compound forming the first hard anatomical component, commercialised by the company Stratasys under the Vero (registered trademark) family of polymeric compounds, such as for example the polymeric compound Vero PureWhite (registered trademark) RGD837:

TABLE 1

| Characteristic | Standard (ASTM) | Value | |
|---|---|---|---|
| Tensile strength | D-638-03 | 50-65 | MPa |
| Elongation at break | D-638-05 | 10-25% | |
| Young's modulus | D-638-04 | 2000-3000 | MPa |
| Tg (glass transition | DMA, E» | 52-54° | C. |
| temperature) | | | |
| Shore D hardness | D scale | 83-86 | |
| Cured density | D-792 | 1.17-1.18 | g/cm³ |

Thus, the first polymeric compound can have a Shore D hardness of between 70 and 95, preferably between 83 and 86 as mentioned above in table 1.

Each second soft anatomical component 7, 9, 11, 13 anatomically reproduces, as shown on FIG. 1, at least partially at least one element selected from an optical nerve 7, a pituitary gland 9, carotid arteries 11 and nasal mucous membranes 13.

The second soft anatomical component 7, 9, 11, 13 consists of a second polymeric compound having a second hardness. In this example, the second polymeric compound is a photopolymeric compound, and may comprise at least one elastomer material.

The following table shows an example of physical characteristics of the second polymeric compound forming the second soft anatomical component, commercialised by the company Stratasys, such as for example the polymeric compound Agilus30 (registered trademark) FLX2040:

TABLE 2

| Characteristic | Standard (ASTM) | Value | |
|---|---|---|---|
| Tensile strength | D-412 | 2.4-3.1 | MPa |
| Elongation at break | D-412 | 220-270% | |
| Compression assembly | D-395 | 6-7% | |
| Tear strength | D-624 | 5-7 | kg/cm |
| Shore A hardness | D-2240 | 30-35 | |
| Cured density | D-792 | 1.14-1.15 | g/cm³ |

Thus, the second polymeric compound can have a Shore A hardness of between 20 and 95, preferably between 27 and 60, for example between 30 and 35 as mentioned above in table 1.

Such a polymeric compound Agilus30 (registered trademark) can also be combined with at least one other polymeric compound to modify the hardness of the second polymeric compound. For example, such a polymeric compound Agilus30 (registered trademark) can be combined with a polymeric compound of the aforementioned family of Vero (registered trademark) polymeric compounds, in particular to increase the hardness of the second polymeric compound, depending on the hardness of the anatomical element to be reproduced by the second soft anatomical component 7, 9, 11, 13. Thus, each second soft anatomical component 7, 9, 11, 13 may consist of a second different polymeric compound and have a different hardness, in order to obtain a hardness similar to that of the anatomical element reproduced by the second soft anatomical component considered.

Thus, in this example, the or each second polymeric compound has a lower hardness than that of the or of each first polymeric compound.

In the example shown, optionally, at least one soft anatomical component, such as for example the carotid arteries 11, can be filled and can therefore contain a liquid reproducing a biological liquid, for example a red liquid reproducing blood.

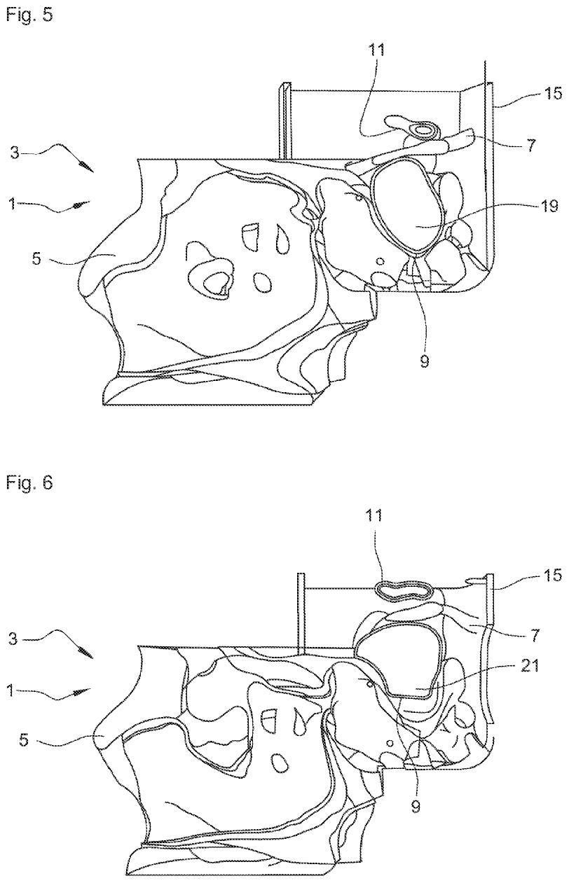

The third anatomical component 17, 19, 21 consists of a third polymeric compound, the compound in this example being different from the first polymeric compound and from the second polymeric compound. The third polymeric compound is a brittle material. In the examples shown on FIGS. 4 to 6, the third anatomical component 17, 19, 21 is surrounded by a second anatomical component 9 reproducing a pituitary gland. In the example shown on FIG. 4, the third anatomical component 17 reproduces a tumour, more precisely a pituitary microadenoma. In the example shown on FIG. 5, the third anatomical component 19 reproduces a tumour, more precisely a pituitary macroadenoma. In the example shown on FIG. 6, the third anatomical component 21 reproduces a tumour, more precisely a craniopharyngioma.

The third polymeric compound is for example a photopolymeric compound, preferably composed of the support material used to manufacture the simulator, for example the material SUP705 commercialised by the company Stratasys, whose composition is given below:

TABLE 3

| | Content |
|---|---|
| Component | (percentage by weight) |
| Poly(oxy-1,2-ethanediyl), alpha-(1-oxo-2- | <50 |
| propenyl)-omega-hydroxy- | |
| 1,2-Propylene glycol | <35 |
| Polyethylene glycol | <30 |
| Glycerol | <25 |
| Phenylbis(2,4,6-trimethylbenzoyl)phosphine | <0.5 |
| oxide | |
| Acrylic acid ester | <0.3 |

Thus, the third polymeric compound can make the third anatomical component brittle. Thus for example, it can be removed by mechanical action, for example by scrubbing or scraping. For example, such a compound is also at least partially water-soluble and can be removed under the action of a water jet.

As aforementioned, the assembly 3 comprises a unit 15 for maintaining in suspension the second soft anatomical component 7, 11. Thus, in the examples shown on FIGS. 1 to 6, the first hard anatomical component 5 and the second soft anatomical component 7, 11 are rigidly connected together via the unit 15. The unit 15 further consists of the same first polymeric compound as the first hard anatomical component 5.

On FIGS. 1 to 6, the unit 15 has a cubic or substantially cubic shape. The unit 15 is open on one side, and the four sides of the unit 23, 24, 25, 26 adjacent to the open side, which form a peripheral wall, each have at least one orifice 29, 31, 33. In the example shown on FIG. 1, the unit 15 comprises stiffening means formed by two fillets 35, 37. Thus, the side 23 is connected to the side 24 via the fillet 35, and the side 24 is connected to the side 25 via the fillet 37. The unit 15 may also or alternatively comprise, as stiffening means, at least one rib and/or at least one fold. For example, a fold can be formed on the edge of the peripheral wall, at the open side, and can be formed towards the internal space of the unit 15.

On FIGS. 1 to 6, the second soft anatomical component 7, 11 is connected to the peripheral wall of the unit 15 by material complementarity. The second soft anatomical component 7, 11 is then arranged at least partially in the internal space delimited by the unit 15, and is suspended in the unit 15.

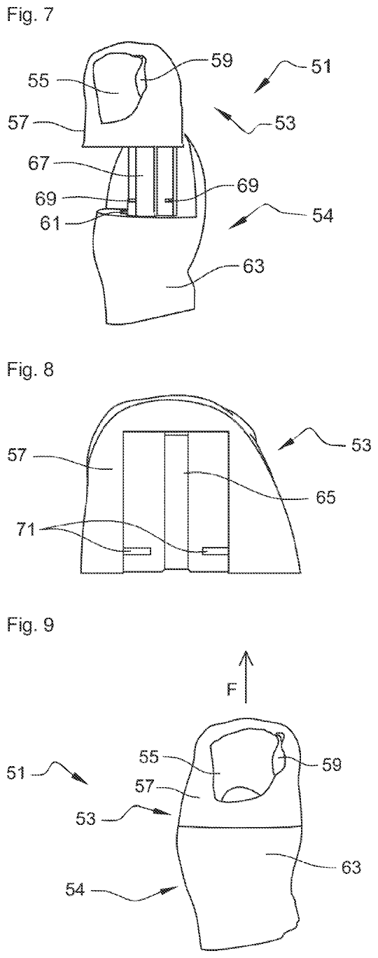

FIGS. 7 and 9 show a surgical operation training simulator according to a second embodiment of the invention, designated by the general reference 51.

In this example, the simulator 51 comprises an assembly 53 anatomically reproducing a portion of a human body, more precisely an end of a big toe. The simulator also comprises a support 54 to which the assembly 53 is removably attached.

The assembly 53, like the assembly 3 of the first embodiment, is in one piece and comprises a first hard anatomical component 55, which anatomically reproduces in this example an ungular portion, in this case a nail. Thus, the first anatomical component 55 consists of the first polymeric compound. The assembly 53, like the assembly 3 of the first embodiment also comprises at least one second soft anatomical component 57, 59, which reproduces soft tissues. Each second soft anatomical component 57, 59 consists of a second polymeric compound, having a lower hardness than that of the first polymeric compound. Thus, the description of the first embodiment applies to this second embodiment, especially as regards the materials and characteristics of the hard, respectively soft, anatomical components.

In the example shown, the support 54 anatomically reproduces a portion of a human body, more precisely in this example a portion having the shape of a big toe complementary to the assembly 53.

The support 54 comprises a first hard anatomical component 61, which reproduces at least partially a bone forming a phalange, and at least one second soft anatomical component 63, which reproduces soft tissues.

In the example shown on FIGS. 7 to 9, the assembly 53 and the support 54 form a sliding connection together, whose sliding degree of freedom is blocked by blocking means. The sliding connection is a dovetail sliding connection, formed by a groove 65 carried by the assembly 53 and a tenon 67 carried by the support 54. Due to the presence of the groove 65 on the assembly 53, less material is required to make the assembly 53, thereby reducing its cost.

In the example shown on FIGS. 7 to 9, the blocking means comprise clipping means. These clipping means comprise, as shown on FIG. 7, two lugs 69 located on the support 54. In this example, the lugs 69 of semi-cylindrical shape are located each side of the tenon 67 and are substantially perpendicular to the sliding direction of the sliding connection. The blocking means further comprise, as shown on FIG. 8, two housings 71—located on the assembly 53—for receiving the lugs 69. In this example, the housings 71 of hollow semi-cylindrical shape are located each side of the groove 65 and are substantially perpendicular to the sliding direction of the sliding connection.

In this example, the tenon 67 consists of the first polymeric compound and is therefore hard. In this example, the groove consists of a second polymeric compound and is therefore soft, the hardness of the groove being lower than that of the tenon. Thus, the tenon 67 of the support 54 is not damaged when assembling the assembly 53 and the support 54 and during the relative sliding of the tenon 67 and of the groove 65. This is particularly adapted to the fact that the assembly is interchangeable and is not necessarily reusable once the simulation has been completed, while the support can be kept for a large number of surgical operation training sessions.

Similarly, the lugs 69 consist of the first polymeric compound, and the housings 71 consist of a second polymeric compound. Thus, the lugs 69 of the support 54 are not damaged when assembling the assembly 53 and the support 54 and when clipping the lugs 69 in the housings 71. In addition, the lugs of the support 54 are also not damaged when they come out of the housings 71 when separating the assembly 53 and the support 54 under the action of a separation force F in a direction parallel to the sliding axis of the sliding connection.

Optionally, the blocking means located on the assembly 53 can be destroyed at least partially so that, in the destroyed state, the assembly 53 and the support 54 can be separated. For example, the assembly 53 may comprise tabs which deform when assembling the assembly 53 and the support 54, but which tear off or detach from the assembly 53 when separating the assembly 53 and the support 54 under the action of a separation force F in a direction parallel to the sliding axis of the sliding connection. Thus, the assembly 53 cannot be reused.

An example of a method for manufacturing a simulator 1 according to the first embodiment will now be described.

Firstly, a three-dimensional image of a portion of a human body is produced, in this case a portion of a head. This image is also called the initial model. This step can for example be performed using a three-dimensional scanner. As an alternative, such a three-dimensional image can be produced beforehand and stored on a computer.

The method comprises a step a) of displaying the three-dimensional image of the portion of a human body to be modified, the three-dimensional image being called the initial model.

Then a step b) of modifying this three-dimensional image is performed to define:
a first digital model of a first sub-portion of a head comprising a first modified sub-portion, called the assembly model 3, the assembly model 3 comprising at least one first sub-model of a first hard anatomical component 5 and at least one second sub-model of a second soft anatomical component 7, 9, 11, 13.

In this example, the method comprises, during this step, modifying the assembly model 3 to integrate therein and/or modify at least one sub-model of physical sign representative of a pathology, in this example a tumour. Thus, the assembly model also comprises at least one third sub-model of a third anatomical component 17, 19, 21.

In this example, the method comprises, during this step, modifying the assembly model 3 to integrate therein a sub-model of a unit 15.

Lastly, a step c) of additive synthesis of the assembly 3 is performed using the assembly model, during which all the elements 5, 7, 9, 11, 13, 15, 17, 19, 21 forming the assembly 3 are manufactured simultaneously. Thus, this step c) of additive synthesis is unique.

Such a step comprises for example a sub-step of additive synthesis of the simulator 1 with a support material, for example on a three-dimensional printing machine such as a 3D printer of type J750 commercialised by the company Stratasys. This sub-step can be followed by a sub-step of removing support material used during additive synthesis to obtain a simulator 1 in the finished state, for example using at least a water jet. In this respect, the presence of orifices 29, 31, 33 in the unit 15 simplifies this step of removing support material. In addition, although the third anatomical component 17, 19, 21 consists of the support material, it is not destroyed under the action of the water jet, since the third anatomical component 17, 19, 21 is completely surrounded by the second anatomical component 9 reproducing the pituitary gland. As a result, the water cannot reach the support material of the third anatomical component 17, 19, 21.

An example of a method for manufacturing a simulator 51 according to the second embodiment will now be described.

Firstly, a three-dimensional image of a portion of a human body is produced, in this case a portion of a big toe. This image is also called the initial model. This step can for example be performed using a three-dimensional scanner. As an alternative, such a three-dimensional image can be produced beforehand and stored on a computer.

The method comprises a step a) of displaying the three-dimensional image of the portion of a human body to be modified, the three-dimensional image being called the initial model.

Then a step b) of modifying this three-dimensional image is performed to define:
a first digital model of a first sub-portion of a big toe comprising a first modified sub-portion, called the assembly model 53, the assembly model 53 comprising at least one first sub-model of a first hard anatomical component 55 and at least one second sub-model of a second soft anatomical component 57, 59;
a second digital model of a second sub-portion of a big toe complementary to the first sub-portion of a big toe, comprising a second modified sub-portion, called the support model 54.

In this example, the assembly model 53 is also modified during this step to integrate therein a sub-model of the groove 65 and of the two housings 71.

In this example, the support model 54 is also modified during this step to integrate therein a sub-model of the tenon 67 and of the two lugs 69.

Lastly, a step c) of additive synthesis of the assembly 53 is performed using the assembly model, and a step d) of additive synthesis of the support 54 is performed using the support model 54.

Steps c) and d) can be performed simultaneously or successively, it being possible to perform step c) before step d) and vice versa.

Since the assembly 53 is interchangeable, once the training has been completed, it is possible to only perform step c) in order to renew the assembly 53 to obtain a simulator 51 which is once again operational.

Step c) can also be performed several times, simultaneously and/or successively, to produce a stock of several assemblies 53 for a support 54.

Steps c) and d) of additive synthesis for this second embodiment are similar to step c) described for the first embodiment. Thus, a step c) of additive synthesis of the assembly 53 is performed using the assembly model, during which all the elements 55, 57, 59, 65, 71 forming the assembly 53 are manufactured simultaneously. Thus, this step c) of additive synthesis is unique.

Similarly, a step d) of additive synthesis of the support 54 is performed using the support model, during which all the elements 61, 63, 67 forming the support 54 are manufactured simultaneously. Thus, this step d) of additive synthesis is unique.

The invention is not limited to the embodiments described and other embodiments will be clearly apparent to those skilled in the art. In particular, the embodiments can be combined to obtain a simulator comprising an assembly, comprising a unit for suspending at least one second soft anatomical component, and a support comprising a shape complementary to the assembly, for example anatomically reproducing at least one portion of a human or animal body.

The invention can be applied to a large number of surgical operation simulations. Thus, for example, a simulator according to the invention can comprise an assembly anatomically reproducing at least one portion of a human jaw, the assembly being in one piece and comprising at least:
a first hard anatomical component reproducing at least one cortical bone portion—also called basal bone—of a lower jaw, consisting of a first polymeric compound having a first hardness,
a second soft anatomical component reproducing at least one gum portion, consisting of a second polymeric compound, the second polymeric compound having a lower hardness than that of the first polymeric compound, the first hard anatomical component and the second soft anatomical component being rigidly connected to each other.

Such a simulator may also comprise another first hard anatomical component reproducing at least one spongy portion—also called alveolar process—of a lower jaw, consisting of another first polymeric compound having another first hardness.

Such a simulator may also comprise a support to which the assembly is attached,
the support anatomically reproducing at least one portion of a human or animal body,
the support comprising a shape complementary to the assembly, the assembly preferably reproducing a portion of a jaw with at least one tooth missing, and the support reproducing a portion complementary to said jaw, with teeth.

The assembly may further comprise another first hard anatomical component reproducing at least one tooth. The support may further comprise another first hard anatomical component reproducing at least one tooth.

1. A surgical operation training simulator having an assembly which anatomically reproduces at least one portion of a human or animal body, characterised in that the assembly is in one piece and comprises at least:
a first hard anatomical component consisting of a first polymeric compound having a first hardness,
a second soft anatomical component consisting of a second polymeric compound,
the second polymeric compound having a lower hardness than that of the first polymeric compound, the first hard anatomical component and the second soft anatomical component being rigidly connected to each other.

2. The simulator according to claim 1, wherein the assembly comprises at least a third anatomical component consisting of a third polymeric compound different from the first polymeric compound and from the second polymeric compound, the third anatomical component reproducing a physical sign representative of a pathology.

3. The simulator according to claim 1, wherein the first and second polymeric compounds are photopolymeric compounds, and the second polymeric compound comprises at least one elastomer material.

4. The simulator according to claim 1, wherein the first polymeric compound has a Shore D hardness of between 70 and 95.

5. The simulator according to claim 1, wherein the second polymeric compound has a Shore A hardness of between 20 and 95.

6. The simulator according to claim 1, wherein:
the first hard anatomical component reproduces at least partially at least one element selected from the group composed of: a bone element, a cartilaginous element, a keratinous element, a calcic element, an ungular element, a tooth, a carapace, a corn, a cyst, and a first physical sign representative of a pathology, and
the second soft anatomical component reproduces at least partially at least one element selected from the group composed of: a soft tissue, an adipose tissue, a vein, an artery, a nerve, skin, a muscle, a mucous membrane, a ligament, a tendon, a membrane, an organ, and a second physical sign representative of a pathology.

7. The simulator according to claim 1, wherein at least one of the anatomical components contains a liquid reproducing a biological liquid.

8. The simulator according to claim 1, the simulator comprising a support to which the assembly is attached,
the support anatomically reproducing at least one portion of a human or animal body,
the support comprising a shape complementary to the assembly.

9. The simulator according to claim 8, wherein the assembly and the support form a sliding connection together, whose sliding degree of freedom is blocked by blocking means.

10. The simulator according to claim 1, wherein the assembly further comprises a unit for maintaining in suspension the second soft anatomical component, the unit consisting of a polymeric compound, the first hard anatomical component and the second soft anatomical component being rigidly connected together via the unit.

11. The simulator according to claim 10, wherein the unit is of polyhedral shape open on one side, at least one other side of the unit adjacent to the open side comprising at least one orifice.

12. A method for manufacturing a simulator according to claim 1, comprising the following steps:
a) a step of displaying a three-dimensional image of a portion of a human or animal body to be modified, the three-dimensional image being called the initial model,
b) a step of modifying this three-dimensional image to define a first digital model of a first sub-portion of a human or animal body comprising a first modified sub-portion, called the assembly model, the assembly model comprising at least one first sub-model of a first hard anatomical component and at least one second sub-model of a second soft anatomical component, and
c) a step of additive synthesis of the assembly, performed using the assembly model, during which the first hard anatomical component and the second soft anatomical component are manufactured simultaneously.

13. The simulator according to claim 2, wherein the third anatomical component is brittle.

14. The simulator according to claim 2, wherein the physical sign representative of a pathology is a tumor.

15. The simulator according to claim 4, wherein the Shore D hardness is between 83 and 86.

16. The simulator according to claim 5, wherein the Shore A hardness is between 27 and 60.

17. The simulator according to claim 5, wherein the Shore A hardness is between 30 and 35.

18. The simulator according to claim 6, wherein the first physical sign representative of a pathology is a tumor, and wherein the second physical sign representative of a pathology is a tumor.

19. The simulator according to claim 8, wherein the assembly reproduces a finger end comprising a nail and the support reproduces a portion complementary to said finger.
